(19) United States
(12) Patent Application Publication
(10) Pub. No.: US 2010/0090662 A1
(43) Pub. Date: Apr. 15, 2010

(54) CHARGER SYSTEM FOR RECHARGEABLE LITHIUM BATTERIES UTILIZING POWER SUPPLY TERMINAL AS INITIAL CHARGING MEANS, AND COMPLETING CHARGING VIA INTERNAL CONSTANT-VOLTAGE CHARGER

(76) Inventor: Tadashi OKUTO, Lung Tan (TW)

Correspondence Address: SINORICA, LLC, 2275 Research Blvd., Suite 500, ROCKVILLE, MD, 20850, US

(21) Appl. No.: 12/354,858

(22) Filed: Jan. 16, 2009

(30) Foreign Application Priority Data
Oct. 9, 2008 (TW) 97138993

(51) Int. Cl. H02J 7/06; H02J 7/04

(52) U.S. Cl. 320/164; 320/162

(57) ABSTRACT

The present invention discloses a charger system for rechargeable lithium batteries, which comprises a power supply terminal, a first switch device, a second switch device, a charging unit, a DC/DC converter, and a controller. The power supply terminal provides power with two ends thereof respectively coupled to the first switch device and a protection circuit. The first switch device is coupled to the second switch device. The first switch device and the second switch device are respectively coupled to the protection circuit. The charging unit is coupled to the protection circuit and the second switch device and has a plurality of charging bays. The charging bays respectively receive lithium batteries and are respectively parallel coupled to constant-voltage chargers to charge the lithium batteries. The DC/DC converter is coupled to the constant-voltage chargers. The controller is coupled to the DC/DC converter, the charging unit and the protection circuit respectively.

### BACKGROUND OF THE INVENTION

1. Field of the Invention

The present invention relates to a charger system for rechargeable lithium batteries, particularly to a charger system able to provide each individual lithium battery with an independent current to fine tune the charging voltages.

2. Description of the Related Art

Recently, the battery development is focused on the lithium battery because it has advantages of lightweight, high capacity, low price and environment friendliness. However, the lithium battery may risk smoking, firing or even exploding when the charging voltage exceeds 4.3V repeatedly. If the lithium battery is placed at a voltage of less than 2.0V for a long time, it may no more be reused or recharged. Over-charging or over-discharging may shorten the service life of the lithium battery or bring about an unexpected accident, such as explosion.

Refer to FIG. 1 and FIG. 2. In an ideal case of charging lithium batteries, a charger 12 is used to charge three cascaded lithium batteries 14, 16 and 18, and the charger 12 is set to stop charging when the batteries respectively have voltages of 4.2V.

Refer to FIG. 3. In order to make the three cascaded lithium batteries 14, 16 and 18 respectively have voltages of 4.2V, the charger 12 should output a voltage of 12.6V. However, the voltage of the lithium battery 14 may rise faster than other lithium batteries because of their individual characteristics and application environments. In such a case, the lithium battery 14 is over-charged (at a voltage of 4.3V), and the lithium batteries 16 and 18 is under-charged (at a voltage of 4.15V). Thus, lithium metal precipitates in the lithium battery 14, which may bring about smoking, firing or even exploding.

The abovementioned technology is frequently used at present. However, it compromises the safety and capacity of lithium batteries.

To overcome the problem of uneven voltage and capacity, some prior arts proposed a solution shown in FIG. 4, wherein a charger 22 is cascaded to a set of parallel lithium batteries 24 and 24′, a set of parallel lithium batteries 26 and 26′ and a set of parallel lithium batteries 28 and 28′. Further, a set of cascaded MOS1 (metal oxide semiconductor field effect transistor) and first impedance R1 is paralleled to the set of parallel lithium batteries 24 and 24′; a set of cascaded MOS2 and second impedance R2 is paralleled to the set of parallel lithium batteries 26 and 26′; a set of cascaded MOS3 and third impedance R3 is paralleled to the set of parallel lithium batteries 28 and 28′.

For some reason, the set of lithium batteries 24 and 24′ will reach a voltage of 4.2V faster than other sets of lithium batteries during charging. At this time, MOS1 turns on, and the first impedance R1 partitions the total charging current Ic to have a current 12. Thus, the current charging the lithium batteries 24 and 24′ is decreased, and the voltage rising of the lithium batteries 24 and 24′ is also reduced. At this time, the currents charging the lithium batteries 26 and 26′ and the lithium batteries 28 and 28′ remain unchanged, and the voltages of the lithium batteries 26 and 26′ and the lithium batteries 28 and 28′ keep on rising. Thereby, the charging current for the batteries having reached a voltage of 4.2V is decreased, and the charging currents for the other batteries are maintained unchanged. Then, the batteries cascaded to the distal end of the charging circuit can also reach the intended voltage. The abovementioned charging circuit has been generally used now.

The abovementioned method decreases the voltages of the lithium batteries 24 and 24′ via partitioning the charging current. However, voltage decrease causes the increase of the total charging current Ic. Thus, the voltage will rise again although the voltage has been intentionally lowered via partitioning the current. Besides, the difference between the internal impedances of the lithium batteries 24 and 24′ creates a loop current ILOOP therebetween, and the circuit for offsetting the voltage imbalance will make the system more complicated.

Then should be controlled the turn-on timings of the MOS's and the values of the partitioned currents to solve the abovementioned problem. Accordingly, the present invention proposes a charger system for rechargeable lithium batteries to solve the abovementioned problem.

### SUMMARY OF THE INVENTION

The primary objective of the present invention is to provide a charger system for rechargeable lithium batteries, which does not use the complicated conventional fine-tuning technology but adopts a simpler method to achieve a better effect than the conventional technology.

Another objective of the present invention is to provide a charger system for rechargeable lithium batteries, which is distinct from the conventional technology that provides current to fine tune the charging process in different sections at different timings, and which provides each individual lithium battery with an independent minor current to fine tune the charging voltages.

The present invention proposes a charger system for rechargeable lithium batteries, which comprises a power supply terminal, a first switch device, a second switch device, a charging unit, a DC/DC converter, and a controller. The power supply terminal provides power with two ends thereof respectively coupled to the first switch device and a protection circuit. The first switch device is coupled to the second switch device. The first switch device and the second switch device are respectively coupled to the protection circuit. The charging unit is coupled to the protection circuit and the second switch device and has a plurality of charging bays. The charging bays respectively receive lithium batteries and are respectively parallel coupled to constant-voltage chargers to charge the lithium batteries. The DC/DC converter is coupled to the constant-voltage chargers and providing charging currents for the constant-voltage chargers. The controller is coupled to the DC/DC converter, the charging unit and the protection circuit respectively. When any one of the cascaded lithium batteries reaches a voltage of 4.2V during charging the lithium batteries, the second switch device is turned off to interrupt the charging current from the power supply terminal (the external charger). At the same time, the DC/DC converter is turned on to power the internal constant-voltage chargers. Then, each of all the constant-voltage chargers takes over to charge the corresponding lithium battery until the corresponding lithium battery reaches a voltage of 4.2V.

Distinct from the conventional technology that provides current to fine tune the charging process in different sections at different timings, the charger system of the present invention provides each individual lithium battery with an independent minor current to fine tune the charging voltages. As the present invention is exempted from the complicated conventional fine-tuning technology, the present invention can realize fine tuning more easily and have a better effect than the conventional technology.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing an ideal case of charging lithium batteries in the conventional technology;

FIG. 2 is a diagram schematically showing a physical case of charging lithium batteries in the conventional technology;

FIG. 3 is a diagram schematically showing the charging voltages corresponding to different lithium batteries in the conventional technology;

FIG. 4 is a diagram schematically showing the charger circuit of the conventional technology;

FIG. 5 is a diagram schematically showing the architecture of a charger system according to one embodiment of the present invention;

FIG. 6 and FIG. 7 are diagrams schematically showing the physical relationships of voltage and current in charging lithium batteries with a charger system according to the present invention.

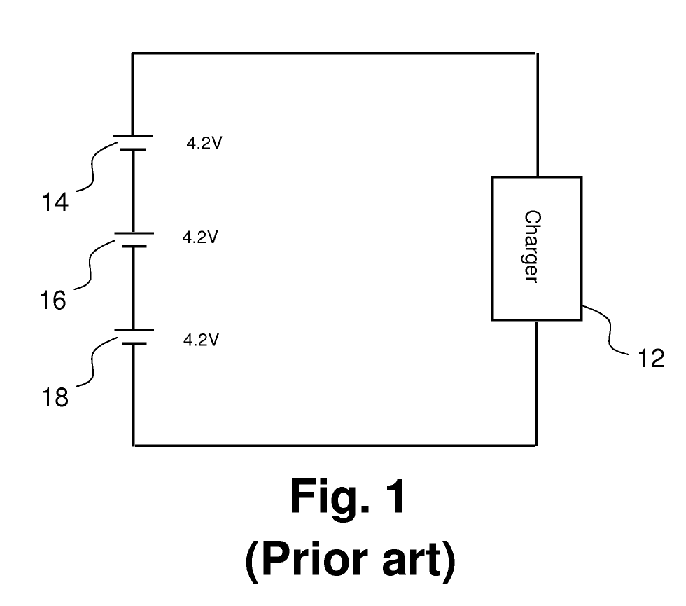

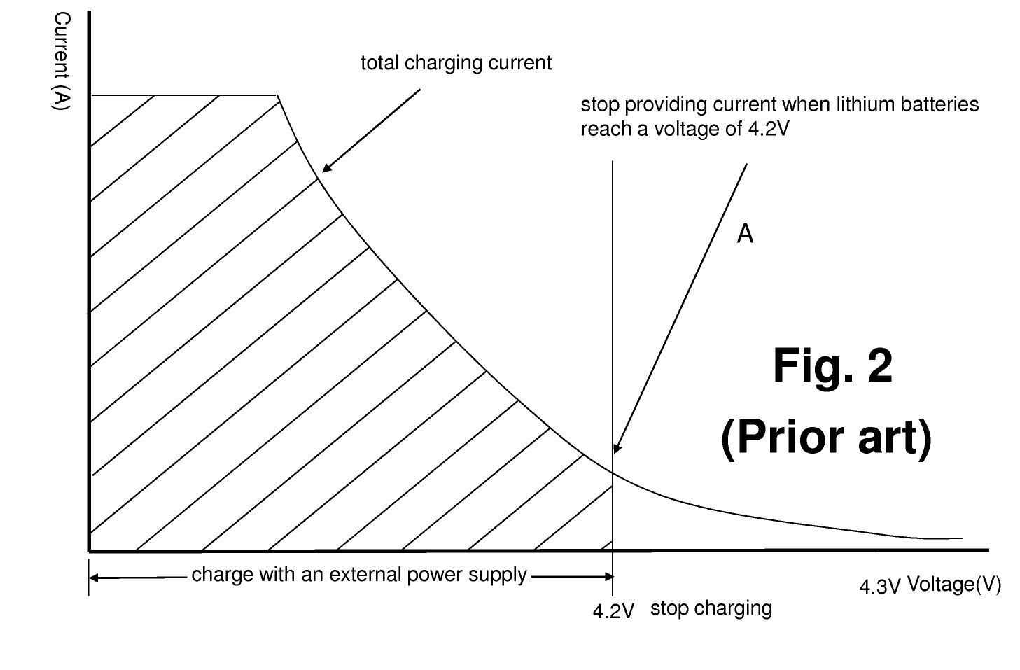

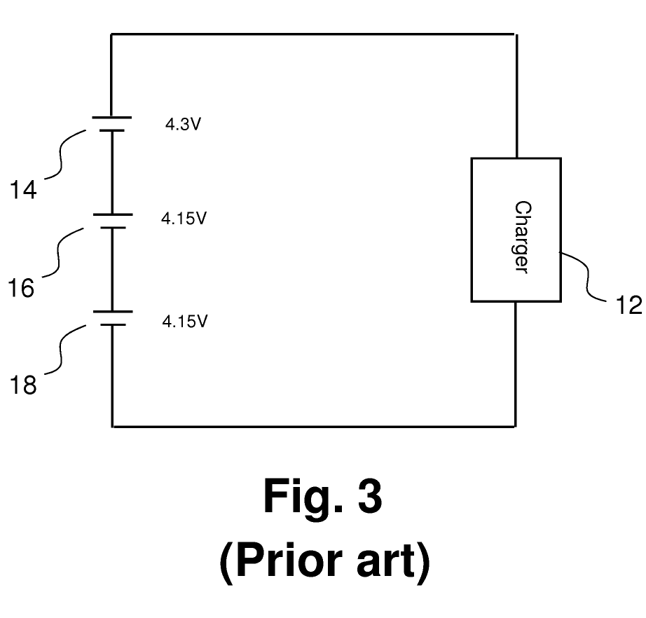

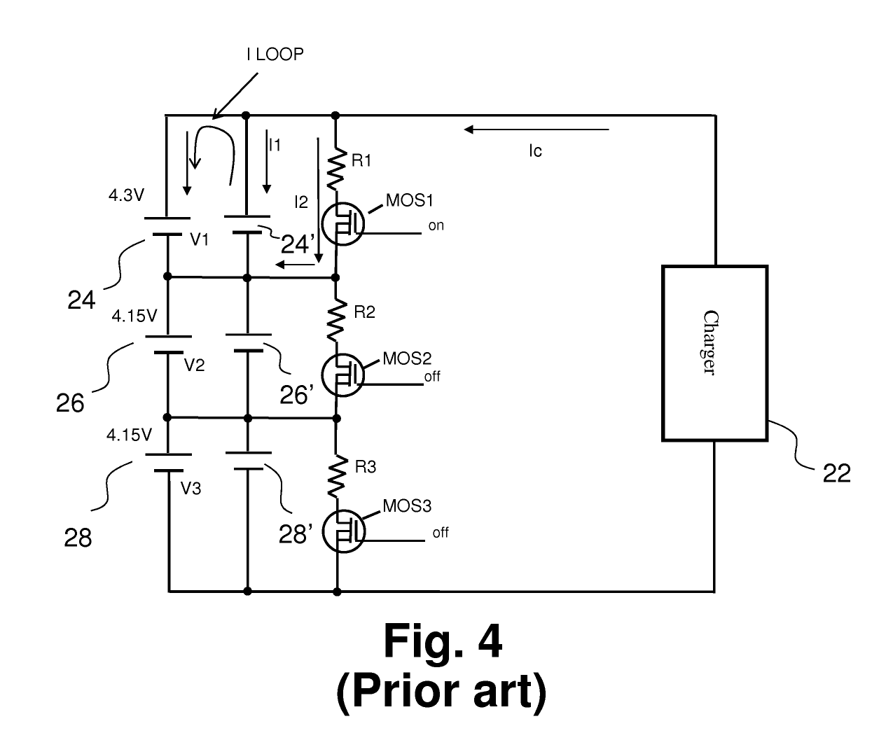

### DETAILED DESCRIPTION OF THE INVENTION

The charger system for rechargeable lithium batteries of the present invention applies to portable computers, portable multimedia players, mobile phones, lithium battery chargers, etc. The technical contents of the present invention will be described in detail below.

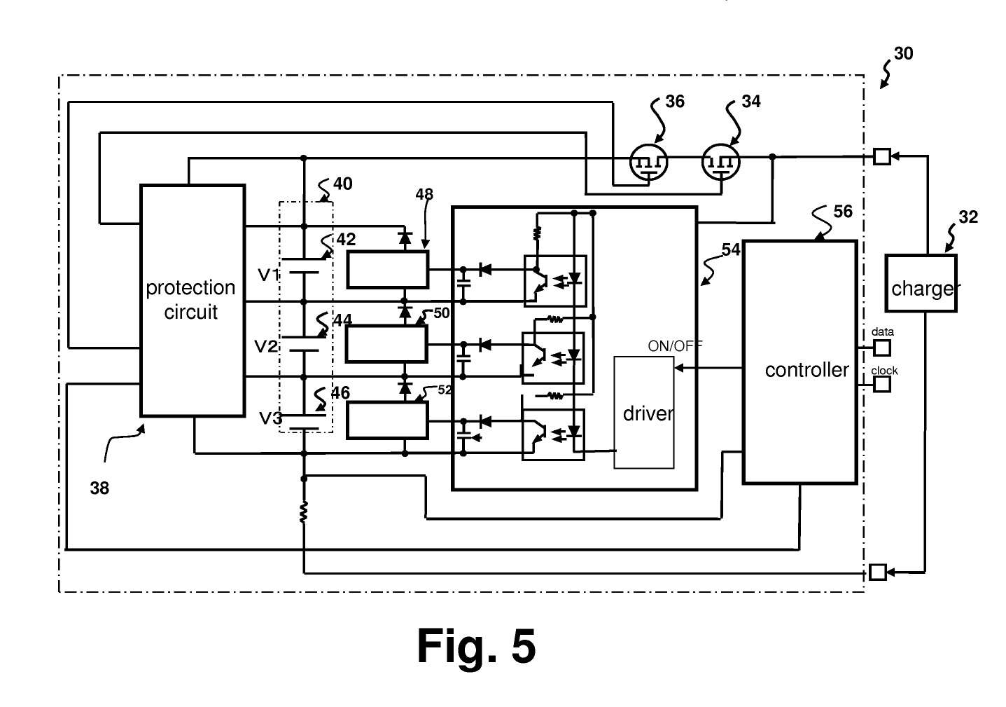

Refer to FIG. 5. The charger system 30 for rechargeable lithium batteries of the present invention comprises a power supply terminal 32, a first switch device 32, a second switch device 34, a charging unit 40, a DC/DC converter 54, and a controller 56.

The power supply terminal 32 provides power. The first switch device 34 is coupled to the second switch device 36. One terminal of the first switch device 34 is coupled to a protection circuit 38. The first switch device 34 and the second switch device 36 are used to switch current. In this embodiment, the first switch device 34 and the second switch device 36 are Metal Oxide Semiconductor Field Effect Transistors (MOSFET). During charging, the first switch device 34 and the second switch device 36 are turned on. Other devices having a switching function, such as other transistors, may be used as the substitutes for the first switch device 34 and the second switch device 36.

The charging unit 40 is coupled to the protection circuit 38 and the second switch device 36 and has a plurality of charging bays to charge lithium batteries. In this embodiment, there are three charging bays 42, 44 and 46, which are respectively parallel connected with internal 4.2V constant-voltage chargers 48, 50 and 52.

The DC/DC converter 54 is coupled to the 4.2V constant-voltage chargers 48, 50 and 52. The controller 56 is respectively coupled to the DC/DC converter 54, the charger unit 40 and the protection circuit 38. When the charger system 30 of the present invention is used to charge a portable computer, the controller 56 is coupled to the portable computer and shows the residual capacities of the lithium batteries on the screen of the portable computer.

The controller 56 also monitors the voltages of the lithium batteries in the charging bays 42, 44 and 46 and controls the DC/DC converter 54 to charge the lithium batteries.

The charger system 30 uses the power provided by the power supply terminal 32 to charge the lithium batteries in the charging bays 42, 44 and 46. When any one of the lithium batteries reaches a voltage of 4.2V, the second switch device 36 is turned off to stop using the power provided by the power supply terminal 32 to charge the lithium batteries. At the same time, the lithium batteries continue to be charged by the internal 4.2V constant-voltage chargers 48, 50 and 52 powered by the DC/DC converter 54.

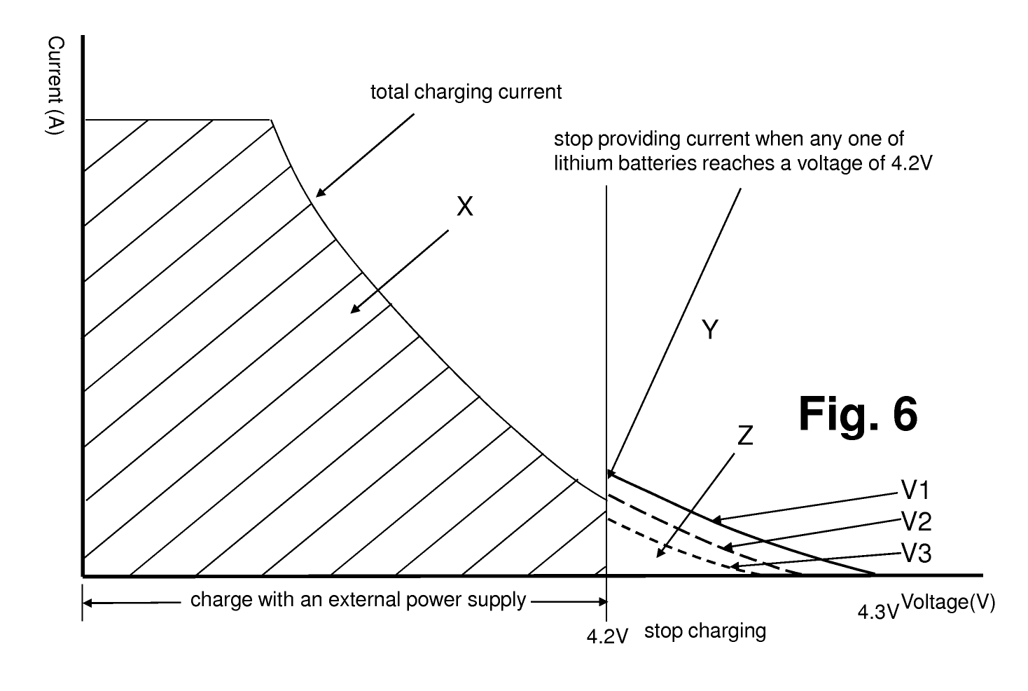

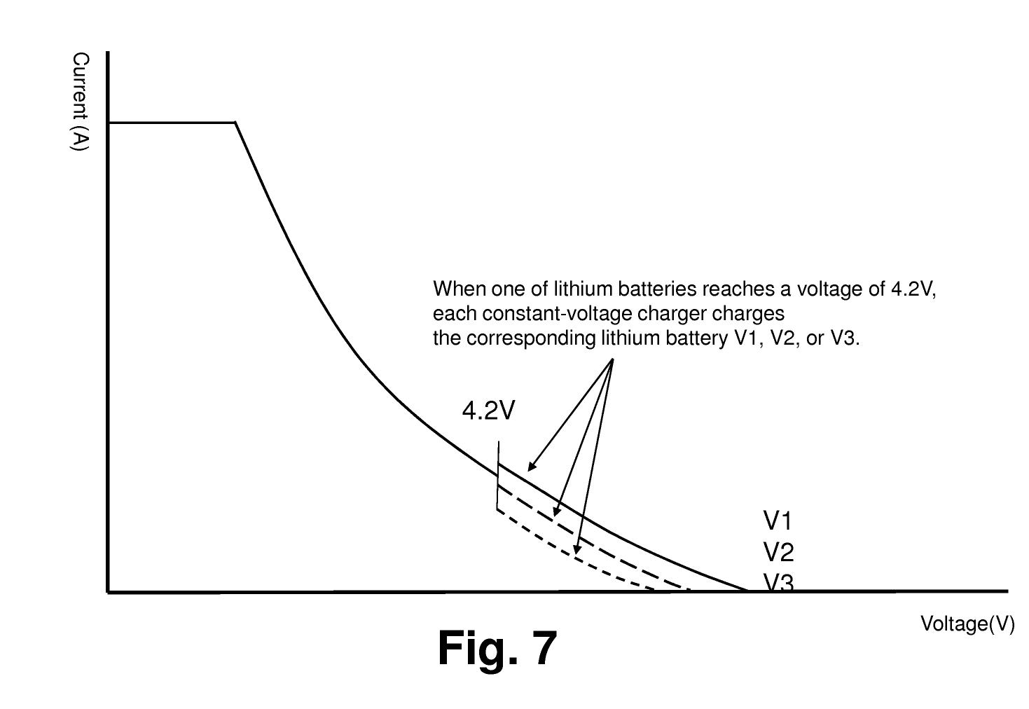

Refer to FIG. 6 and FIG. 7. When the voltages of the lithium batteries are at a relative low level (2.0V˜4.2V), the power supply terminal 32 (the external charger) uses a higher current to charge the lithium batteries (the oblique-line area X in FIG. 6). When any one of the lithium batteries reaches a voltage of 4.2V (Point Y in FIG. 6), the internal 4.2V constant-voltage chargers 48, 50 and 52 use smaller currents to keep on charging the lithium batteries, whereby heat generated inside the charger system is also reduced.

Then, the charging currents, which are respectively corresponding to the voltages of the batteries, flow through the batteries (represented by Area Z in FIG. 6). Although each 4.2V constant-voltage charger 48, 50 or 52 uses different time interval to finish charging the corresponding lithium battery, it will stop charging when the corresponding lithium battery reaches a voltage of 4.2V.

Distinct from the conventional technology that provides current to fine tune the charging process in different sections at different timings, the charger system of the present invention adopts the 4.2V constant-voltage chargers 48, 50 and 52 to fine tune the voltages of lithium batteries, and each constant-voltage chargers 48, 50 or 52 provides the corresponding lithium battery with an independent minor current until the corresponding lithium battery reaches a voltage of 4.2V. Therefore, the present invention can realize fine tuning more easily and have a better effect than the conventional technology.

The embodiments described above are only to exemplify the present invention but not limit the scope of the present invention. Therefore, any equivalent modification or variation according to the shapes, structures, characteristics or spirit disclosed in the specification is to be also included within the scope of the present invention, which is based on the claims stated below.

1. A charger system for rechargeable lithium batteries, comprising:
a power supply terminal providing power;
a first switch device coupled to a second switch device, wherein said first switch device and said second switch device are respectively coupled to a protection circuit and power supply terminal;
a charging unit coupled to said protection circuit and said second switch device, having a plurality of charging bays, wherein said charging bays respectively receive lithium batteries and are respectively coupled to constant-voltage chargers to charge said lithium batteries;
a DC/DC converter coupled to said constant-voltage chargers;
a controller coupled to said DC/DC converter, said charging unit and said protection circuit respectively; and
the controller monitors the voltages of the lithium batteries and controls the DC/DC converter to charge the lithium batteries,
wherein the second switch device is turned off when one of said lithium batteries reaches a voltage of 4.2V, and each of all said constant-voltage chargers charges a corresponding one of said lithium batteries until said corresponding one of said lithium batteries reaches a voltage of 4.2V.

2. The charger system for rechargeable lithium batteries according to claim 1, which applies to portable computers, portable multimedia players, mobile phones, and lithium battery chargers.

3. The charger system for rechargeable lithium batteries according to claim 2, wherein said controller is coupled to a portable computer and shows residual capacities of lithium batteries on a screen of said portable computer.

4. The charger system for rechargeable lithium batteries according to claim 1, wherein said first switch device and said second switch device are metal oxide semiconductor field effect transistors (MOSFET).

5. A method of recharging lithium batteries, comprising,
charging the lithium batteries by an external charger;
charging the lithium batteries by internal chargers when any one of said lithium batteries reaches a voltage of 4.2V charged by the external charger.
